(19) United States
(12) Patent Application Publication
(10) Pub. No.: US 2010/0170431 A1
(43) Pub. Date: Jul. 8, 2010

(54) AIR-FLOATING DEVICE FOR RESCUE

(76) Inventor: Shin-Cheng Lin, Taipei (TW)

Correspondence Address: SCHMEISER OLSEN & WATTS, 18 E UNIVERSITY DRIVE, SUITE # 101, MESA, AZ, 85201, US

(21) Appl. No.: 12/349,597

(22) Filed: Jan. 7, 2009

(51) Int. Cl. B64B 1/40

(52) U.S. Cl. 116/210

(57) ABSTRACT

The present invention discloses an air-floating device for rescue, which comprises a portable box divided into several compartments, a gas bottle containing a gas lighter than the air, a reel having an appropriate length of string, balloons, and ribbons of different colors. The gas bottle, balloons, reel, and ribbons are respectively arranged inside the compartments. When a disaster or disorientation occurs during an activity like mountain-climbing or rafting, the balloon is filled with the gas from the gas bottle and tied with the ribbon and string at the mouth, and then let the balloon float high above to make a conspicuous mark for the rescue team. Further, the color of the ribbon indicates the status of casualty, such as injury or death.

### BACKGROUND OF THE INVENTION

1. Field of the Invention

The present invention relates to an air-floating device for rescue, particularly to a rescue-signaling device used to make a conspicuous mark in the air to request rescue as well as to show the status of casualty when disaster or disorientation occurs during activities like mountain climbing or rafting.

2. Description of the Related Art

Nowadays, radio and mobile phone are the technologies used to request rescue when a disaster, including personal casualty, or disorientation occurring in an activity such as mountain climbing or rafting. However, transmission of radio wave is easily affected by the terrain, environment, weather, and battery condition. Therefore, it is usually hard to report the precise location timely. Although fire and smoke may be used to indicate the location of disaster, they are also limited by the weather condition that makes the rescue team hard to pinpoint the location. The abovementioned problems are likely to delay rescue and cause unnecessary loss. Therefore, the conventional technologies still have much room to improve. Based on many years' experience in related fields, the Inventor has been persistently devoted to researches and experiments and finally proposes the present invention to solve the conventional problems, whereby the disaster location can be indicated accurately, and rescue can be undertaken promptly.

### SUMMARY OF THE INVENTION

The primary objective of the present invention is to provide an air-floating device for rescue, which can make a conspicuous mark in the air to request rescue as well as to show the status of casualty when a disaster or disorientation occurs in the an activity like mountain climbing or rafting, whereby the rescue team can make a timely rescue.

The air-floating device of the present invention comprises a portable box divided into several compartments, a gas bottle containing a gas lighter than the air, a reel having an appropriate length of string, at least one balloon, and a plurality of ribbons of different colors. The gas bottle, balloons, reel, and ribbons are respectively arranged inside the compartments. When a disaster or disorientation occurs during an activity like mountain climbing or rafting, the balloon is filled with the gas from the gas bottle and tied with the ribbon and string at the mouth of the balloon, and then let the balloon float high above to make a conspicuous mark for the rescue team. Further, the different colors of the ribbon indicate the status of casualty, such as injury or death.

In the present invention, the gas bottle is filled with a gas that is lighter than the air. Therefore, the balloon inflated with the gas can float up in the air.

In the present invention, the ribbons tied to the balloon have different colors, including black, red and yellow, which respectively represent death, injury and disorientation.

### BRIEF DESCRIPTION OF THE DRAWINGS

FIG. 1 is a perspective view of an air-floating device for rescue according to the present invention;

FIG. 2 is a perspective view schematically showing how the balloon is inflated according to the present invention; and

FIG. 3 is a perspective view schematically showing that the air-floating device for rescue is brought into practice according to the present invention.

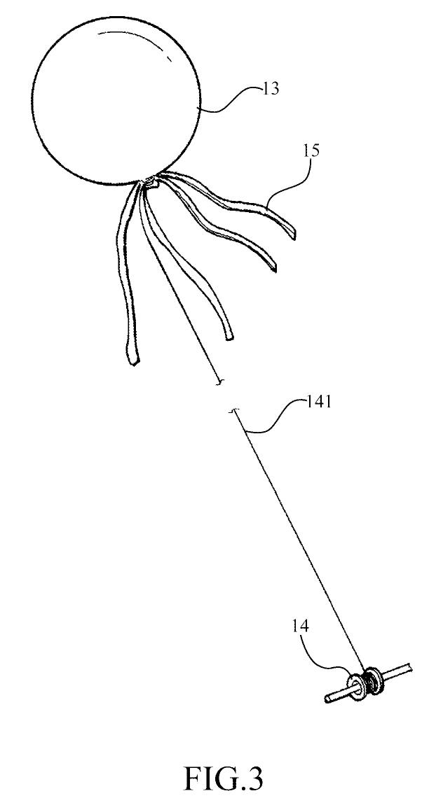

### DETAILED DESCRIPTION OF THE INVENTION

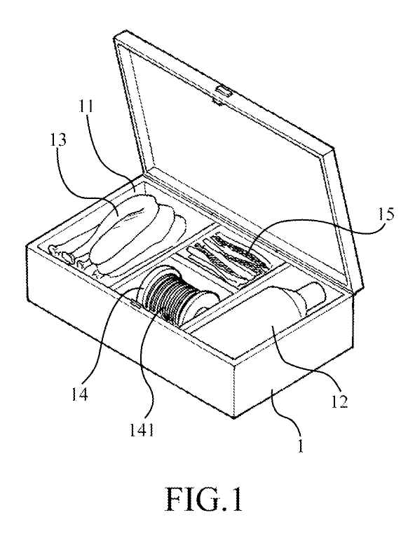

Referring to FIG. 1, the air-floating device of the present invention comprises a portable box 1 divided into several compartments 11, a gas bottle 12 containing a gas lighter than the air, at least one balloon 13, a reel 14 having an appropriate length of string 141, and a plurality of ribbons 15 of different colors. The gas bottle 12, balloons 13, reel 14, and ribbons 15 are respectively arranged inside the compartments 11. The string 141 is made of a material having an appropriate strength. The colors of the ribbons 15, including black, red and yellow, respectively represent death, injury and disorientation.

The package of the air-floating device is carried by the crew when they undertake an activity like mountain climbing or rafting. When a disaster or disorientation occurs, the balloon 13 is filled with the gas from the gas bottle 12 and tied with the ribbon 15 and string 14 at the mouth of the balloon, and then let the balloon 13 float high above to make a conspicuous mark to indicate the casualty location for the rescue team. Additionally, the status of casualty, such as death or injury, is expressed by the colored ribbon 15 to facilitate the rescue team making proper preparation.

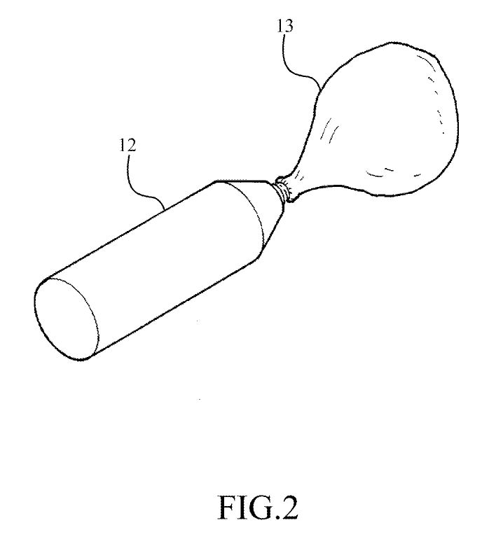

Referring to FIG. 2, the air-floating device of the present invention is to be carried about by the crew when they undertake an activity like mountain climbing or rafting. When a disaster or disorientation occurs, the balloon 13 is taken out from the portable box 1. Next, the inflation tip of the gas bottle 12 is inserted into the mouth of the balloon 13 to fill the gas into the balloon 13. As the gas of the gas bottle 12 is lighter than the air, the balloon 13 can float up in the air.

When the balloon inflation is done, the mouth of the balloon 13 is tied with the string 14 and the colored ribbons 15. As the gas of the gas bottle 12 is lighter than the air, the balloon 13 can float high in the air to function as a conspicuous mark, whereby the rescue team can precisely pinpoint the casualty location and undertake rescue as soon as possible. Additionally, the ribbons 15 tied to the balloon 13 have different colors, including black, red and yellow, which respectively represent death, injury and disorientation. According to the colors of ribbons 15, the rescue team thus may carry proper equipments or medicine to give a timely and effective rescue.

In conclusion, the present invention proposes an air-floating device for rescue, which is to be carried about by the crew of an activity like mountain-climbing or stream-tracing. The present invention not only makes a conspicuous mark high above in the air but also shows a casualty status, whereby the rescue team can make an effective rescue as soon as possible. Therefore, the present invention is a useful innovation, possesses novelty and non-obviousness and meets the conditions for a patent. Thus, the Inventor files the application for a patent. It will be appreciated if the patent is fast approved.

What is claimed is:

1. An air-floating device for rescue comprising
a portable box having several compartments;
a gas bottle arranged inside one of said compartments;
a reel having an appropriate length of string and arranged inside one of said compartments;
at least one balloon arranged inside one of said compartments; and
a plurality of ribbons of different colors arranged inside one of said compartments,
wherein when a disaster or disorientation occurs during an activity like mountain climbing or rafting, said balloon is filled with gas from said gas bottle, and said string and one of said ribbon are tied to the mouth of said balloon; then, let said balloon fly high above to make a conspicuous mark for rescue teams, and said ribbon tied to said balloon expresses a casualty status, such as a state of injury or death.

2. The air-floating device for rescue according to claim 1, wherein said ribbons have different colors, including black, red and yellow, which respectively represent death, injury and disorientation.
